(19) United States
(12) Patent Application Publication
(10) Pub. No.: US 2015/0320063 A1
(43) Pub. Date: Nov. 12, 2015

(54) A PROCESS FOR PREPARING A MILK PRODUCT

(71) Applicant: SIEVECORP EUROPE B. V., Haarlem (NL)

(72) Inventors: Paul Willem Mendel, Haarlem (NL); Jorine Zandhuis, (US)

(21) Appl. No.: 14/653,714

(22) PCT Filed: Dec. 20, 2013
(86) PCT No.: PCT/NL2013/050929

§ 371 Date: Jun. 18, 2015

(30) Foreign Application Priority Data
Dec. 20, 2012 (NL) 2010024

(51) Int. Cl. A23C 9/142; A23C 3/02

(52) U.S. Cl. CPC A23C 9/1422; A23C 3/02

(57) ABSTRACT

The invention is directed to a process for preparing a milk product from a raw milk feed comprising microorganisms as obtained by milking a milk delivering animal by separating the microorganism from the raw milk by means of microfiltration. A milk product poor in microorganisms and a retentate milk product enriched in microorganism relative to the raw milk is obtained. The microfiltration is performed as a cross-flow filtration over a sieve, which sieve comprises of a coated silicon cross-flow surface plate with openings that are smaller than the dimensions of the microorganisms present in the raw milk feed and wherein over the sieve a high frequency back pulsing is applied. Microfiltration is performed within 8 hours from obtaining the raw milk feed by milking.

The invention is directed to a process for preparing a milk product from a raw milk feed comprising microorganisms and to the novel long shelf like milk product as obtained by this process.

Raw milk does not have a long shelf life, but spoils in a relatively short amount of time. Spoilage of milk is caused by several factors, including spoilage caused by the milk degrading enzymes. The enzymes present in raw milk can be subdivided in two groups; endogenous enzymes that are naturally present in milk (originating from the animal) and bacterial enzymes secreted by external bacteria that infect the milk upon milking of the animal. Amongst both types of enzymes are milk degrading enzymes that cause spoilage of the milk. The enzymes may cause degradation of certain milk components, in particular degradation of milk proteins (e.g. casein) and of lipids, thereby causing the milk to spoil.

Accordingly, raw milk is processed in order to minimize possible health hazards, to maximize its shelf life and to preserve the physical, chemical, sensory and nutritional characteristics of fresh milk. Commonly, milk is heat treated to destruct pathogenic and spoilage microorganisms. Accordingly, the external bacteria are killed and can no longer secrete the enzymes causing spoilage. Furthermore, the endogenous enzymes already present in the raw milk are inactivated by the heat treatment, such that they can no longer cause degradation of the milk. Adversely, the heating process may impose changes including but not limited to protein denaturation, calcium precipitation, vitamin destruction, product browning and off-flavour and off-odour development.

In the field of milk production various processes have been developed for the production of so-called long shelf life milk. Long shelf life milks are milk products which retain their quality over a prolonged period of time when kept at ambient or refrigerated temperatures. The traditional heat treatment poses a dilemma for the production of long shelf life milk: increasing the severity of the heat treatment process to ensure the elimination of all microorganisms and particularly of spores will increase product safety and product shelf life but adversely also intensify the chemical, physical, sensory and nutritional changes to the final product.

There are two general types of heat treatment for the production of long shelf life milk. The first is sterilization in which milk is heated to 121° C. for 3 minutes. Sterilization destroys all microorganisms, but severely affects product quality as exampled by milk browning, a caramelised taste and reduced nutritional value. The second treatment is Ultra High Temperature (UHT) pasteurization in which milk is heated in excess of 135° C. for approximately 4 seconds. UHT milk is whiter, tastes less caramelised and has reduced protein denaturation and vitamin destruction. Nevertheless, product quality cannot compare to fresh milk and during storage off-flavours (e.g. stale or oxidized flavour) are developed.

Mild heat treatments that do not severely affect product quality and produce milk that consumers perceive as ‘fresh milk’ are not effective enough to produce a long shelf life milk. Most common mild heat treatment is High Temperature Short Time (HTST) pasteurization, in which milk is heated to 72° C. for 15-20 seconds. HTST does not destroy enough heat resistant microorganisms such as spores, nor destroys enough heat resistant milk-degrading enzymes present in milk, to produce long shelf life milk.

Efforts are taken to solve the dilemma of long shelf life milk by decreasing the physical, chemical, sensory and nutritional changes caused by milk processing, while maintaining the necessary microbiological safety levels.

Such an effort is described in WO2010/085957. This publication describes a process wherein a heat treatment at a temperature in the range of 140-180° C. for at most 200 milliseconds, is preceded by a physical separation of microorganisms from the milk. The physical separation may be achieved by centrifugation employing e.g. a bactofuge (Tetra Pak Dairy processing Handbook 2003 ISBN 91-631-3427-6) or by microfiltration using e.g. isoflux ceramic tubular membranes with 0.8 μm pore size. Furthermore, WO2010/085957 shows in their long shelf time experiments that protein denaturation is decreased and that less lactulose is present in the milk as obtained in their process as compared to UHT milk. They further found that off-flavour development, as determined by 2-heptanone and 2-nonanone content, is lower than in UHT milk. However, the experimental data provided by the inventors in exemplary embodiment 1, still indicate increased protein denaturation and off-flavour development as compared to raw and pasteurized milk.

A further disadvantage of the above processes to prepare long shelf milk is their complexity. Multiple processing steps are required to obtain the end product.

US2010/0310711 is directed to a method of microfiltering milk. In this method, the milk is microfiltered at a temperature approximate to the body temperature of the organism that produced the milk, such that the fat molecules present in the milk are small, dispersed and warm; meaning in a liquid state. Accordingly, the milk can be filtered before the fat molecules coalesce into globules that are too large to pass through the filter. One way of achieving this feature is by microfiltering the milk immediately after it is drawn from the cow. The filters described are the Pall Corporation 1.4 micron filter and the Pall Corporation MEMBRALOX ceramic filter. US2010/0310711 does not describe or suggest that the time between milking the animal and microfiltering may have any effect on shelf life.

An object of the invention is to provide a method for increasing the shelf life of milk, while affecting the taste of the milk to a minimal extent. In particular, an object of the invention is to provide a method for microfiltering milk, which results in a product having excellent shelf life. A further object is to provide a simple and efficient process to prepare a high-quality milk product.

This object was met by providing a process for preparing a milk product from a raw milk feed comprising microorganisms as obtained by milking a milk delivering animal by separating the microorganism from the raw milk by means of microfiltration resulting in the milk product poor in microorganisms and a retentate milk product enriched in microorganism relative to the raw milk, wherein the microfiltration is performed as a cross-flow filtration over a sieve, which sieve comprises of a coated silicon cross-flow surface plate with openings that are smaller than the dimensions of the microorganisms present in the raw milk feed and wherein over the sieve a high frequency back pulsing is applied and wherein the microfiltration is performed within 8 hours from obtaining the raw milk feed by milking.

The inventors found that by using a short time period between milking the milk delivering animal and conducting the above-described microfiltration, a milk product with excellent shelf life was obtained. This was a surprising result, because microfiltration is generally not capable of activating or removing endogenous enzymes. Therefore, one would expect that the presence of the endogenous milk degrading enzymes would still cause the milk to spoil in a few weeks time. However, the inventors found that this is not the case.

Without wishing to be bound by theory, it is suspected that presence of bacterial enzymes influences the activity of the endogenous enzymes and the natural balance between their native activators and inhibitors. For example, the bacterial enzymes may stimulate and/or activate the endogenous enzymes, thereby increasing the activity of the endogenous enzymes and resulting in the milk to spoil. However, by removing the bacteria through microfiltration, bacterial enzymes are no longer present in the milk and the endogenous enzymes, though still fully functional, remain in their dormant form and do not cause the milk to spoil. Furthermore, it is expected that the specific high-frequency backpulsing filtration may also play a role in achieving the particularly good shelf life obtained with the method of the invention.

Furthermore, the inventors found that the product obtained in the method of the invention has physical, chemical, sensory and nutritional quality characteristics that are at least comparable to, and preferably enhanced with respect to, the characteristics of HTST milk. No further heat treatment is required to obtain a product having the excellent shelf life and above characteristics according to the invention. Thus a more simplified process is obtained.

A further advantage is that the retentate milk product may also be used to make a milk product by means of any prior art process. The retentate milk product will be of substantially the same composition as the permeate milk product except for the content of microorganisms and would compare with an untreated raw milk in which microorganisms have been allowed to cultivate.

The microfiltration is performed within 0-8 hours as from the drawing of the milk feed from a milk-producing animal. By strongly decreasing the time between milking and microfiltration, the microorganisms, and especially the psychotropic bacteria, that infect the milk are not allowed the time to accustom to their new surroundings (the milk) and start growing and excreting enzymes. Accordingly, the resulting milk is very poor in bacterial milk-degrading enzymes but still contains unchanged native milk-degrading enzymes. Surprisingly, applicants found that said native enzymes have low activity during the shelf life of milk produced by the above process. The milk delivering animal is typically a dairy animal, such as a cow, a sheep or a goat.

Applicants found that by using a coated silicon cross-flow surface plate as the sieve having well defined openings an almost total physical separation of microorganism from the raw milk is possible resulting in that commercially sterilized milk may be obtained in which physical, chemical, sensory and nutritional characteristics of the milk remain unchanged. The defined openings allow a sharp cut-off point so that all microorganisms are retained while all native milk ingredients are passed through unchanged. Additional advantages of said exact cut-off point are improved operational parameters such as increased flux rates and decreased fouling. Sieves comprising a coated silicon sieve having a surface plate as described above are known in the art and typically referred to simply as coated silicon sieves.

As explained above, with the process according to the invention milk with high microbial safety levels and low milk-degrading enzymatic activity is obtained. Said milk thus has a long shelf life without being subjected to a high heat treatment. By not having to perform a high heat treatment physical, chemical, sensory and nutritional changes of the milk product as a result of such heat treatment is avoided.

The invention is also directed to a milk product obtained by the process according to the invention. The product is typically not subjected to any additional high heat treatment. By high heat treatment is hereby meant any treatment wherein the milk is heated to a temperature above 80° C., more especially above 100° C. Examples of such heat treatment are UHT pasteurization, sterilization, and heat treatments such as described in WO2010/085957 in which the milk is heated above 100° C. for at most 200 milliseconds. Without wishing to be bound by any theory, it is expected that since the milk is not subjected to such heat treatments, the endogenous enzymes present in the milk product of the invention will be in their native form. In contrast, such enzymes would be irreversibly inactivated (e.g. denatured) in milk that has been subjected to a heat treatment.

In the context of present invention, the term “milk or milk-related product” relates to milk-based products which may contain many, if not all, of the components of skim milk and optionally may contain various amounts milk fat, and possibly also non-dairy additives such as non-dairy flavours, sweeteners, minerals and/or vitamins.

The milk feed may be any milk feed. The milk may be of various animal sources including, but not limited to, human, cow, sheep, goat, dear and buffalo. Preferably cow milk is used. The milk feed may also have any percentage of milk-fat and can for example be fat-free, low-fat, full-fat or cream. The milk feed may have non-dairy additives such as non-dairy flavours, sweeteners, minerals and/or vitamins.

The milk feed may have any temperature and may be directly processed after milking. The milk may also be cooled, in order to slow down bacterial growth, and subsequently be subjected to the above process, or be heated again before being subjected to the above process. Cooling and heating may be performed by indirect heat exchange against a cooling medium, such as ground water, or a heating medium, such as steam. The temperature of the milk feed may be between 2 and 70° C., suitably between 20 and 60° C., and preferably between 40-55° C. For example, the raw milk may have a temperature below 35° C. or below 30° C. during microfiltration.

Current invention describes a process for preparing a milk product by a cross-flow filtration over a sieve, which sieve comprises of a coated silicon cross-flow surface plate. A coated silicon cross-flow plate is a sieve that is manufactured from a silicon surface. The silicon surface may be coated to give the surface favourable characteristics. An example of such a coating is a nitride coating that is employed to render the silicon surface more hydrophilic. In the silicon surface plate openings that account for the porosity and macrostructures serving for increasing the strength of the sieve or reducing the fouling potency of the sieve, may be manufactured by photolithographic techniques. An example of such a sieve plate and its manufacture is described in WO2005/023404 and EP-B-1667788, which publications are hereby incorporated by reference.

Preferably the coated silicon cross-flow surface plate has exactly defined openings resulting in a very sharp cut-off point. The openings in the coated silicon cross-flow plate are smaller than the dimensions of the microorganisms such that these microorganisms cannot pass the cross-flow surface plate. This results in a process wherein more than 99.999% (log 5), preferably more than 99.99999% (log 7), preferably even more than 99.9999999% (log 9) of the number of microorganisms are separated from the raw milk.

Suitably the openings in the coated silicon cross-flow surface plate are obtained by etching as exampled by the etching process described in the afore mentioned WO2005/023404 and EP-B-1667788. Preferably the largest dimension of an opening in the cross-flow plate is smaller than 800 nm, more preferably smaller than 450 nm or even more preferably smaller than 350 nm as measured by means of a scanning electron microscope. Such a sieve plate will thus have very well defined openings that do not allow any microorganisms to pass. This is very advantageous compared to when using other microfiltration sieves, such as ceramic filters. Because the openings in ceramic filters as used in WO2010/085957 or US2010/0310711 are not well defined a log 5 or higher reduction of microorganisms is difficult to achieve or only possible by using sieves having even smaller average openings. The smaller openings have the disadvantage that also valuable milk components such as casein proteins are separated from the milk product. Moreover, because of the smaller pores ceramic filters get easily fouled resulting in poor filtration efficiency.

The openings in the coated silicon cross-flow surface plate may have a circular or slit form opening. The diameter of the circular opening or the width of the slit typically has a length of between 200 and 800 nm, preferably between 300 and 600 nm.

The sieve is preferably part of a microfiltration unit comprising an inlet space for raw milk, an outlet for the milk product and an outlet for the retentate milk product, all fluidly connected to one or more parallel operated cross-flow units, each cross-flow unit comprising an inlet space fluidly connected to the inlet for raw milk and fluidly connected to the outlet for the retentate milk product, a permeate space fluidly connected to the outlet for the milk product, the coated silicon cross-flow surface plate fluidly dividing the inlet space from the permeate space.

Back pulsing may be achieved by interruption of the flow of raw milk to the sieve or more preferred by increasing the pressure at the permeate side of the cross-flow surface plate. Preferably the frequency of back pulsing is between 5 and 40 times per second. Preferably the permeate space of a cross-flow unit further comprises a buffer volume which increases and decreases in volume resulting in a temporal pressure reversal across the cross-flow surface plate such to achieve back pulsing. Such units are known and described in WO2008/127098 and especially as shown in FIG. 2 of WO2008/127098. Suitably the buffer is a bellow which can increase and decrease in volume. The bellow may for example increase in volume by pumping a gas into the below or more preferred by mechanically increasing its volume. The decrease of bellow volume will result from the pressure in the permeate space. Preferably the bellow is mechanically pressed to its larger volume at a frequency of between 5 and 40 times per second.

The apparatus may comprise 1 or more parallel operated units. The number of units will in part depend on the required capacity. If the process is for example performed at a small milk farm with up to 100 cows, 1 to 10 units may suffice. If the process is performed on a diary plant with a capacity of more than 10,000 litres a day, 25 or more units per apparatus may for example be used.

Part of the retentate milk product may be recycled to the inlet space of the one or more cross-flow units. Such an operation is referred to as a cross-flow filtration, whereby the milk feed is pumped along the surface of the sieve plate facing the inlet space, with only a fraction of the milk passing the sieve plate to the permeate space. The retentate is preferably recycled and combined with the raw milk feed. A purge, i.e. the fraction of the retentate which is not recycled, will ensure that the level of microorganisms in the recycle will remain below an acceptable level. Applicants found that the purged retentate product may be used to prepare a second milk product by means of any prior art process. We found that the retentate milk product will be of substantially the same composition as the permeate milk product except for the content of microorganisms and compares with an untreated raw milk in which microorganisms have been allowed to cultivate. Thus by choosing the level at which the retentate is recycled one may influence the relative production of the milk product and the retentate milk product. The fraction of retentate product which is recycled may thus vary within wide ranges, for example between 10 and 100 vol % or between 10 and 99 vol %. If the main product is the milk product obtained by the process according to this invention and no substantial production of the retentate milk product is desired a recycle may be used wherein between 90 and 100 vol %, suitably between 90 and 99 vol % of the retentate milk product is recycled.

Surprisingly, applicants have found that by reducing the time between milking and microfiltration not only the content, but also the activity of milk-degrading enzymes in the resulting milk-product can be strongly reduced. To prevent the excretion of bacterial milk-degrading enzymes, and ensure low activity of native milk-degrading enzymes, the microorganisms are separated from the raw milk within 8 hours, more preferably within 6 hours, more preferably within 4 hours and even more preferably within 2 hours or even more preferably within one hour from obtaining the raw milk feed by milking the milk-delivering animal.

As will be clear to the person skilled in the art, the process may contain one or more additional step(s) that may be added before and after the microfiltration step, including but not limited to a centrifugal step, a homogenization step, storage step, mixing step, temperature adjustment step, HTST pasteurization step, packaging step as well as combinations thereof.

Fat or a fraction of the fat as is present in the raw milk feed may be separated from the raw milk feed prior to subjecting the feed to the microfiltration. Fat may be separated by well known techniques, such as for example centrifugal separation. By separating the fat, the fat will not clog or stay behind in the microsieves. The separated fat may again be added to the milk product (and/or the retentate milk product) after microfiltration. The separated fat is preferably sterilised before it is added to the milk product and/or the retentate milk product. It may be added in any quantity to match the desired fat content in the end product.

In addition or alternatively, the raw milk is homogenized prior to microfiltration. This has the advantage that the fat in the milk will not be present in the form of large globules that are too large to pass through the sieves.

Yet an aspect of the invention relates to a long shelf life milk or milk-related product obtainable by the method as described herein.

The shelf life of a commercial milk product is typically described as the time for which the product can be stored without the quality falling below a certain minimum acceptable level. Causes for product falling below a certain minimum acceptable level include, but are not limited to: the milk or milk-related product is found to contain microorganisms capable of growing in the product at the storage conditions; the milk or milk-related product is found to contain a minimum level of hydrophobic peptides, products of proteolytic degradation, that cause a undesirable, bitter taste; the milk or milk-related product is found to have an undesirable sensory property such as visual appearance, consistency, odour, and taste.

In the context of present invention, the term “long shelf life”, relates to milk products that have shelf lives longer than 2 months, whether refrigerated or at ambient temperatures. As example, HTST pasteurization that produces milk with a shelf life of 1-3 weeks is not regarded a long shelf life milk. As a second example, Extended Shelf Life (ESL) milk products generally have a shelf life between the 3 and 6 weeks and also are not regarded as a long-shelf life milk. UHT milk has a shelf life of 9 or more months and is regarded as a long shelf life milk.

The milk or milk-related product as obtained by the method described above may be part of a commercial milk product having a shelf life of 2 months or more, suitably has a shelf life of 3 months or more, and preferably has a shelf life of 6 months or more. This shelf life is suitably obtained when stored at refrigerated temperatures at 2° C., and preferably when stored at ambient temperatures at 20° C.

The milk or milk-related product as obtained by the method described above typically has low levels of viable microorganisms. When measured immediately following processing and packaging (under aseptic conditions) the product may have a viable organism count, measured as colony forming units/millilitre by standard plate counts, between 0-500 cfu/ml, suitably between 100 cfu/ml and more preferably between 0-10 cfu/ml. In a preferred embodiment of the invention, the milk or milk-related product contains 0 cfu/ml.

The milk or milk-related product as obtained by the method described above typically has physical, chemical, sensory and nutritional quality characteristics that are at least comparable to, but preferably enhanced with respect to, the characteristics of HTST milk.

More specifically, said milk or milk-related product has no or negligible amounts of protein denaturation as indicated by lactulose and furosine levels. When measured immediately following processing the lactulose level of the milk may be between the 0 and 10 mg/ml, suitably is between 0-5 mg/ml and preferably is between 0-2 mg/ml. When measured immediately following processing the furosine level of the milk may be between 0-15 mg/1, suitably is between 0-10 mg/1; and preferably is between 0-5 mg/l.

More specifically, said milk or milk-related product has no or negligible off-flavour development as indicated by the 2-heptanone and 2-nonanone content. When measured immediately following processing the 2-heptanone level of the milk may be between 0-10 μg/L, suitably is between 0-5 μg/L and preferably is between 0-2 μg/L. When measured immediately following processing the 2-nonanone level of the milk may be between 0-10 μg/L, suitably is between 0-5 μg/L and preferably is between 0-2 μg/L. The milk or milk-related product as obtained by the method described above has no or negligible levels of casein micelle retention because of the sharp cut-off point of the silicon crossflow plate. Casein retention may be between 0-20 wt %, suitably is between 0-10 wt %, and preferably is between 0-5 wt %. In case of microfiltration using a ceramic filter a higher casein micelle retention is found due to the particle size of around 125-150 nm of the micelles. Thus a more nutritious milk product is obtained using the process according to the present invention.

1. A process for preparing a milk product from a raw milk feed comprising microorganisms as obtained by milking a milk delivering animal by separating the microorganism from the raw milk by means of microfiltration resulting in the milk product poor in microorganisms and a retentate milk product enriched in microorganism relative to the raw milk, wherein the microfiltration is performed as a cross-flow filtration over a sieve, which sieve comprises of a coated silicon cross-flow surface plate with openings that are smaller than the dimensions of the microorganisms present in the raw milk feed and wherein over the sieve a high frequency back pulsing is applied and wherein the microfiltration is performed within 8 hours from obtaining the raw milk feed by milking.

2. Process according to claim 1, wherein the openings in the coated silicon cross-flow surface plate have a largest dimension of below 800 nm.

3. Process according to claim 2, wherein the openings in the coated silicon cross-flow surface plate have a largest dimension of below 450 nm.

4. Process according to claim 1, wherein the openings are obtained by etching.

5. Process according to claim 1, wherein the frequency of back pulsing is between 5 and 40 times per second.

6. Process according to claim 1, wherein the sieve is part of a microfiltration unit comprising an inlet space for raw milk, an outlet for the milk product and an outlet for the retentate milk product, all fluidly connected to one or more parallel operated cross-flow units, each cross-flow unit comprising an inlet space fluidly connected to the inlet for raw milk and fluidly connected to the outlet for the retentate milk product, a permeate space fluidly connected to the outlet for the milk product, the coated silicon cross-flow surface plate fluidly dividing the inlet space from the permeate space.

7. Process according to claim 6, wherein the permeate space of a cross-flow unit further comprises a buffer volume which increases and decreases in volume resulting in a temporal pressure reversal across the cross-flow surface plate such to achieve back pulsing.

8. Process according to claim 1, wherein more than 99.999% (count) of the microorganisms are separated from the raw milk.

9. Process according to claim 1, wherein the microorganisms are separated from the raw milk within 3 hours from milking the animal.

10. Process according to claim 1, wherein at least a fraction of the fat present in the raw milk is removed from the raw milk prior to subjecting the feed to the microfiltration.

11. Process according to claim 1, wherein the raw milk is homogenized prior to microfiltration.

12. Process according to claim 1, wherein the raw milk has a temperature below 30° C. during microfiltration.

13. Process according to claim 1, wherein the raw milk has a temperature of 40-55° C. during microfiltration.

14. Process according to claim 1, wherein the openings in the coated silicon cross-flow surface plate have a circular or slit form opening wherein the diameter of the circular opening or the width of the slit has a length of between 200 and 800 nm.

15. Process according to claim 14, wherein the diameter or width is between 300 and 600 nm.

16. Process according to claim 1, wherein the retentate milk product is subjected to a pasteurization treatment to obtain a pasteurised milk product.

17. Product obtainable by the process of claim 1.

18. Product obtainable by the process of claim 1, wherein the product comprises endogenous enzymes in their active or native form.

19. Product according to claim 18, wherein the product has not been subjected to a heat treatment above 80° C.

20. Product according to claim 18, wherein the product has not been pasteurized.

21. Use of the retentate milk product as obtained according to the process of claim 1 to make a milk product by pasteurization.
